(19) United States
(12) Patent Application Publication
(10) Pub. No.: US 2013/0340438 A1
(43) Pub. Date: Dec. 26, 2013

(54) METHOD OF REDUCING COMBUSTION INDUCED OSCILLATIONS IN A TURBINE ENGINE

(71) Applicant: Mario E. Abreu, Poway, CA (US)

(72) Inventor: Mario E. Abreu, Poway, CA (US)

(73) Assignee: Solar Turbines Incorporated

(21) Appl. No.: 13/536,070

(22) Filed: Jun. 28, 2012

Related U.S. Application Data
(60) Provisional application No. 61/663,300, filed on Jun. 22, 2012.

(51) Int. Cl. F02C 7/22

(52) U.S. Cl. 60/772

(57) ABSTRACT

Systems and methods for operating a turbine engine having a plurality of fuel injectors arranged circumferentially in a combustor, with each fuel injector having a main fuel supply and a pilot fuel supply, includes supplying fuel to the plurality of fuel injectors through the main fuel supply to create a circumferential thermal gradient in the combustor.

### CROSS REFERENCE TO RELATED APPLICATIONS

This application claims the benefit of priority from U.S. Provisional Application No. 61/663,300 to Mario E. Abreu filed on Jun. 22, 2012.

### TECHNICAL FIELD

The present disclosure relates generally to systems and methods of reducing combustion induced oscillations in a gas turbine engine.

### BACKGROUND

Gas turbine engines produce power by extracting energy from hot gases produced by combustion of a fuel air mixture. Combustion of hydrocarbon fuels produce pollutants, such as NOₓ. Gas turbine engine manufacturers have developed techniques (lean premixed combustion, etc.) to reduce NOₓ. However, one unwanted side effect of such techniques is the appearance of a form of combustion instability, such as thermo-acoustic oscillations in the combustion chamber. These oscillations occur as a result of coupling of the heat release and pressure waves and produce resonance at the natural frequencies of the combustion chamber. This phenomenon is described by the well-known Rayleigh Mechanism. Depending on the amplitude of the oscillations, these oscillations may result in mechanical and thermal fatigue of engine components or cause other adverse affects on the engine. Therefore, it is desirable to reduce the amplitude of these combustion induced oscillations. Several approaches have been developed to reduce the magnitude of thermo-acoustic oscillations in gas turbine engines. These approaches may be broadly classified as active and passive measures. Active measures use an external feedback loop to detect the amplitude of the oscillations, and make a real-time operational change (such as, for example, fueling change) to dampen the oscillations if the detected amplitude exceeds a predetermined value. Passive techniques include increasing acoustical attenuation by design modifications to the gas turbine engine.

U.S. Patent Publication No. US 2007/0074518 A1 (“the '518 publication”) assigned to the assignee of the current application, describes a passive technique to reduce thermo-acoustic oscillations by configuring the length of different regions of the fuel injector to introduce a phase change in the fuel to air equivalence ratio and the pressure waves in the combustor. While the method described in the '518 publication is suitable to reduce oscillations in many applications, some applications may benefit from other techniques of reducing oscillations.

### SUMMARY

In one aspect, a method for operating a turbine engine is disclosed. The turbine engine may include a plurality of fuel injectors arranged circumferentially in a combustor. Each fuel injector may include a main fuel supply and a pilot fuel supply. The method may include supplying fuel to the plurality of fuel injectors through the main fuel supply to create a circumferential thermal gradient in the combustor.

In another aspect, a method for operating a turbine engine is disclosed. The turbine engine may include a plurality of fuel injectors arranged circumferentially in a combustor. Each fuel injector may include a main fuel supply and a pilot fuel supply. The method may include supplying a first quantity of fuel to a first set of fuel injectors of the plurality of fuel injectors. The method may also include supplying a second quantity of fuel lower than the first quantity to a second set of fuel injectors of the plurality of fuel injectors

In yet another aspect, a method for operating a turbine engine is disclosed. The turbine engine may include a plurality of fuel injectors arranged circumferentially in a combustor. Each fuel injector may include a main fuel supply and a pilot fuel supply. The method may include directing a first quantity of fuel into the combustor through a first set of fuel injectors arranged circumferentially around the combustor. The method may also include directing a second quantity of fuel lower than the first quantity through a second set of fuel injectors arranged circumferentially around the combustor. The method may further include combusting the first quantity of fuel and the second quantity of fuel to create a circumferential temperature gradient in the combustor.

### BRIEF DESCRIPTION OF THE DRAWINGS

FIG. 1 is an illustration of an exemplary disclosed gas turbine engine system;

FIG. 2 is a cross-sectional view of a fuel injector coupled to the combustor of the turbine engine of FIG. 1;

FIG. 3A is an illustration of an exemplary end of the fuel injector of the turbine engine of FIG. 1;

FIG. 3B is an illustration of another exemplary end of the fuel injector of the turbine engine of FIG. 1;

FIG. 4A is an illustration of an exemplary gaseous fuel delivery system of the gas turbine engine of FIG. 1;

FIG. 4B is a schematic view of the exemplary gaseous fuel delivery system of FIG. 4A;

FIG. 5A is an illustration of an exemplary liquid fuel delivery system of the gas turbine engine of FIG. 1;

FIG. 5B is an enlarged view of a portion of the liquid fuel delivery system of FIG. 5A;

FIG. 5C is a schematic view of the exemplary liquid fuel delivery system of FIG. 5A; and

FIG. 6 is a schematic illustration of the exemplary variation in the fuel supply to the combustor of the gas turbine engine of FIG. 1.

### DETAILED DESCRIPTION

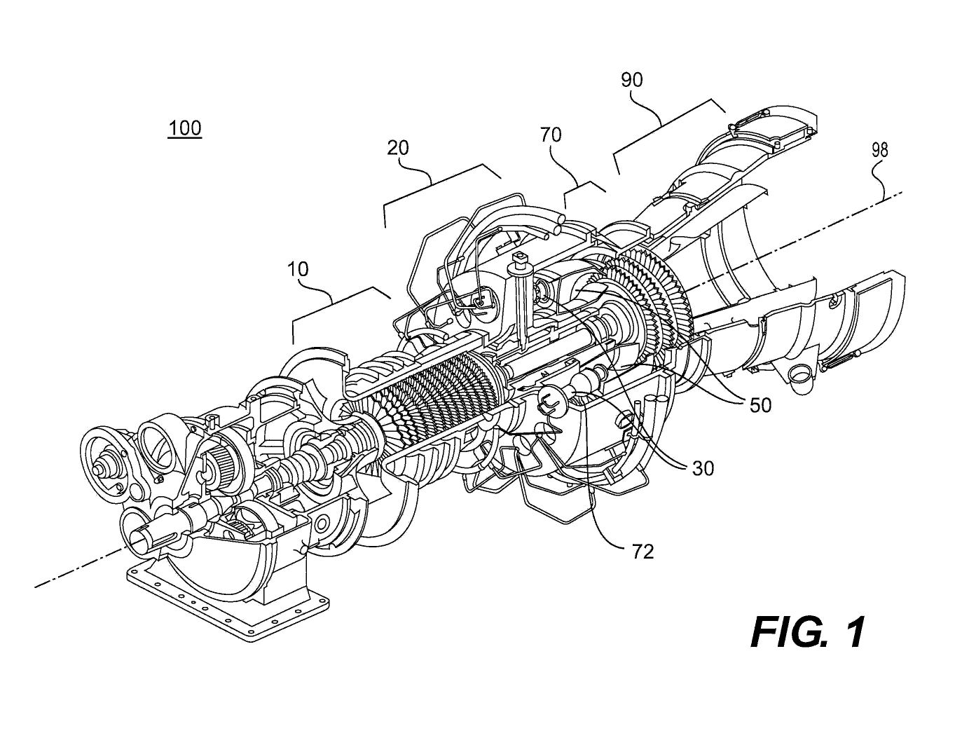

FIG. 1 illustrates an exemplary gas turbine engine (GTE) 100. GTE 100 may have, among other systems, a compressor system 10, a combustor system 20, a turbine system 70, and an exhaust system 90 arranged along an engine axis 98. Compressor system 10 compresses air and delivers the compressed air to an enclosure 72 of the combustor system 20. The compressed air is directed from enclosure 72 into one or more fuel injectors 30 positioned therein. This compressed air is mixed with a fuel in fuel injector 30 and the fuel-air mixture is directed to a combustion chamber (combustor 50). The fuel air mixture ignites and burns in combustor 50 to produce combustion gases at high pressures and temperatures. These combustion gases are then directed to turbine system 70. Turbine system 70 extracts energy from the combustion gases, and directs the exhaust gases to the atmosphere through exhaust system 90.

A liquid fuel (such as, for example diesel fuel, kerosene, etc.) or a gaseous fuel (natural gas, etc.) may be directed to the fuel injectors 30 of GTE 100. In some embodiments of GTE 100, both a liquid fuel and a gaseous fuel may be selectively directed to the combustor 50 through the fuel injectors 30. Embodiments of fuel injectors configured to selectively deliver a gaseous fuel and a liquid fuel to the combustor 50 are called dual-fuel injectors. In dual-fuel injectors, the fuel delivered to fuel injector 30 may be switched between gaseous and liquid fuels to suit the operating conditions of GTE 100. For instance, at an operating site with an abundant supply of natural gas, fuel injector 30 may deliver liquid fuel to combustor 50 during start up and later switch to natural gas fuel to utilize the locally available fuel supply.

The layout of GTE 100 illustrated in FIG. 1, and described above, is only exemplary. The disclosed methods of reducing combustion induced oscillations may be applied to gas turbine engines of any layout and configuration. For instance, the disclosed methods may be applied to gas turbine engines that work only on liquid or a gaseous fuel (referred to as a single-fuel GTE), and to a gas turbine engine that operates on both gaseous and liquid fuels (referred to as a dual-fuel GTE).

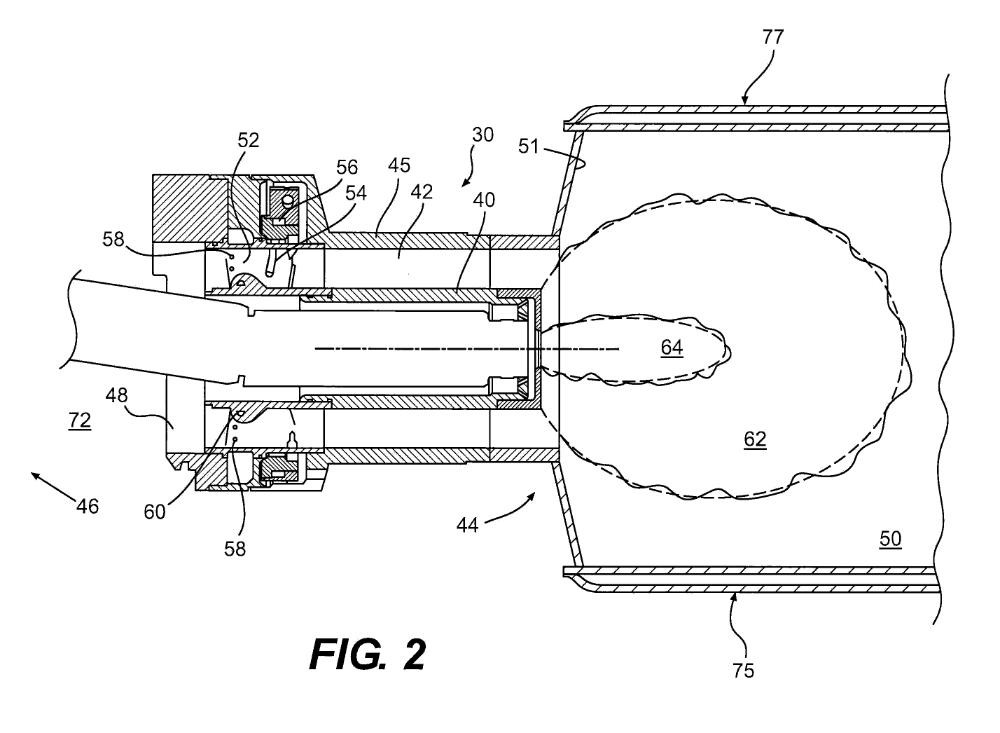

FIG. 2 is an illustration of an embodiment of a dual-fuel injector 30 coupled to combustor 50 of GTE 100. Combustor 50 fluidly couples the compressor system 10 and the turbine system 70 of GTE 100, and includes an annular space enclosed between inner and outer combustor liners 75, 77 spaced apart a predetermined distance. In FIG. 2, combustor 50 is illustrated as an annular combustion chamber that extends around the engine axis 98. Alternatively, GTE 100 could include a plurality of can combustors without changing the essence of the invention. Although FIG. 2 only illustrates one fuel injector 30 coupled to the combustor 50, a plurality of fuel injectors 30 are symmetrically arranged about engine axis 98 at an inlet end portion (dome 51) of combustor 50.

Fuel injector 30 extends from a first end 44, that is coupled to the combustor dome 51, to a second end 46 that is positioned in enclosure 72. Compressed air from enclosure 72 enters fuel injector 30 through openings in a blocker ring 48 positioned between first and second ends 44, 46. This compressed air flows to the combustor 50 through an annular duct 42 formed in a space between a tubular premix barrel 45 and a centerbody that serves as a pilot assembly 40. An air swirler 52 is positioned in the annular duct 42 to induce a swirl to the air stream flowing past it. Liquid fuel, collected in an annular liquid fuel gallery 56, is injected into the air stream in annular duct 42 through fuel nozzles 54 symmetrically arranged around the annular duct 42. This injected liquid fuel mixes with the air in the annular duct 42 to form a liquid fuel-air mixture that flows into the combustor 50. The swirl induced in the air stream by the air swirler 52 helps to create a well mixed fuel-air mixture.

As discussed previously, dual-fuel injectors are configured to selectively direct both a liquid fuel and a gaseous fuel to the combustor 50. When the GTE 100 operates on gaseous fuel, gaseous fuel is injected from an annular gas fuel gallery 60 through orifices 58 into the annular duct 42. This gaseous fuel mixes with the swirled air stream and forms a well mixed gas fuel-air mixture. As illustrated in FIG. 2, in some embodiments, the liquid fuel nozzles 54 and the gas fuel orifices 58 are positioned on the air swirler 52. However, this is only exemplary. In general, these fuel outlets may be positioned anywhere along the annular duct 42.

It should be noted that, although a dual-fuel injector is illustrated in FIG. 2, in a single-fuel GTE 100, the fuel injector 30 may only have components to deliver a single type of fuel to the annular duct 42. The fuel-air mixture directed to the combustor 50 through the annular duct 42 is called the main fuel-air mixture (or main fuel). Typically, the main fuel-air mixture comprises about 92-96% of the total fuel directed to the combustor 50 during normal operation of the GTE 100. To reduce emission of NOₓ (and other pollutants), the main fuel-air mixture is a lean mixture of fuel and air that burns to create a relatively low temperature flame 62 in the combustor 50. However, during some operating conditions, this relatively low temperature flame may be extinguished (called flame out).

To minimize flame outs and maintain a stable flame in the combustor 50, fuel injector 30 directs a parallel stream of a rich fuel-air mixture to the combustor 50 through the centrally located pilot assembly 40. Although not shown in detail in FIG. 2, pilot assembly 40 includes passages (and/or other components) adapted to selectively deliver the liquid and gaseous fuels, and compressed air into the combustor 50 therethrough. The same type of fuel injected into the annular duct 42 is also directed into the pilot assembly 40 through these passages. This fuel and compressed air are sprayed into the combustor 50 to form a rich pilot fuel-air mixture that burns to produce a high temperature flame 64 proximate the exit plane of the fuel injector 30. This high temperature flame 64 helps to anchor and stabilize the low temperature flame 62 produced by the lean main fuel-air mixture. The rich fuel-air mixture directed into the combustor 50 through the pilot assembly is called the pilot fuel-air mixture (or the pilot fuel).

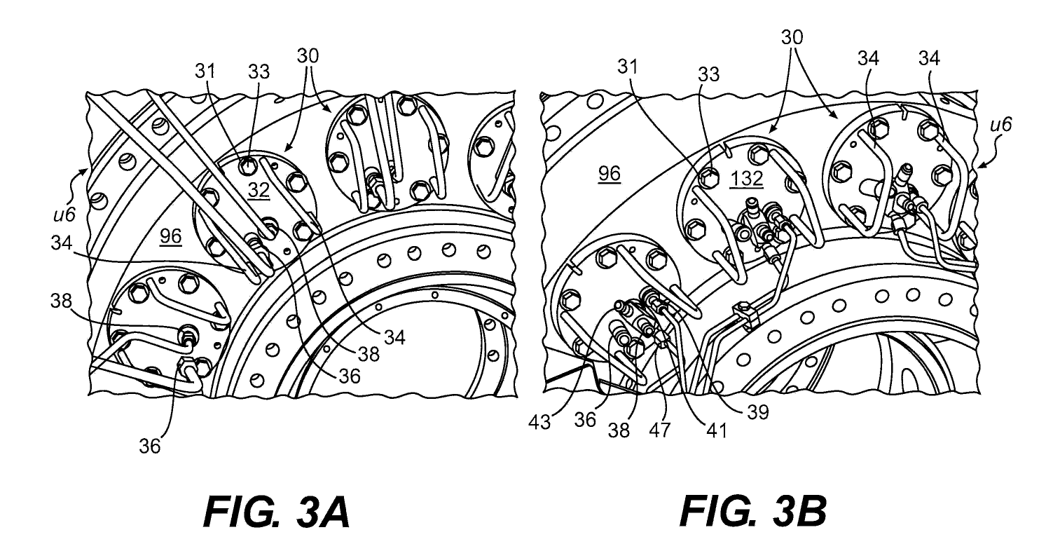

Fuel conduits deliver fuel to the fuel injectors 30 through the second end 46 of the fuel injectors 30. The second end 46 includes components, such as pipe fittings, configured to removably couple fuel conduits to the fuel injectors 30. In some embodiments, these pipe fittings may be located on a flange positioned at the second end 46 of the fuel injector 30. FIGS. 3A and 3B illustrate exemplary flanges 32, 132 positioned at the second end 46 of a fuel injector 30. FIG. 3A illustrates an exemplary flange 32 that may be used with a single-fuel injector, and FIG. 3B illustrates a flange 132 that may be used with a dual-fuel injector. In flange 32, a first pipe fitting 36 may be provided for the main fuel supply and a second pipe fitting 38 may be provided for the pilot fuel supply. Conduits delivering liquid or gaseous fuel (depending upon the type of fuel GTE 100 is operating on) may be coupled to the first and second pipe fittings 36, 38. In a flange 132 used with a dual-fuel injector, two pipe fittings (one for gaseous fuel and one for liquid fuel) may be provided for each of the main fuel supply and the pilot fuel supply. For instance, in flange 132, first, second, third, and fourth pipe fittings 36, 38, 39, and 47 may be provided to couple with conduits delivering gaseous main fuel, gaseous pilot fuel, liquid main fuel, and liquid pilot fuel, respectively, to the fuel injector 30. Additionally, a fifth pipe fitting 43 may be provided for assist air. During engine startup, when GTE 100 operates on liquid fuel, the air assist connection may deliver lower pressure shop air to the pilot assembly 40 to assist in atomizing the liquid fuel of the pilot fuel supply. In some embodiments, as illustrated in FIG. 3B, a plurality of the pipe fittings may be combined together and provided in a single component. The flanges 32, 132 may also include handles 34 that enable the fuel injector 30 to be transported, and features (such as, through-holes 31 and fasteners 33) that enable the fuel injector 30 to be attached to the GTE 100. It should be noted that although a specific configuration and arrangement of pipe fittings, handles, and openings are illustrated in FIGS. 3A and 3B, these are only exemplary. In general, these components and structures may have any shape and may be arranged in any configuration. Further, although flange 132 is described as a flange of a dual-fuel injector, it should be noted that flange 132 may also be used with a single-fuel injector by plugging unused pipe fittings. For instance, as illustrated in FIG. 3B, flange 132 may be used with a liquid only fuel injector 30 by plugging the unused gaseous fuel pipe fittings.

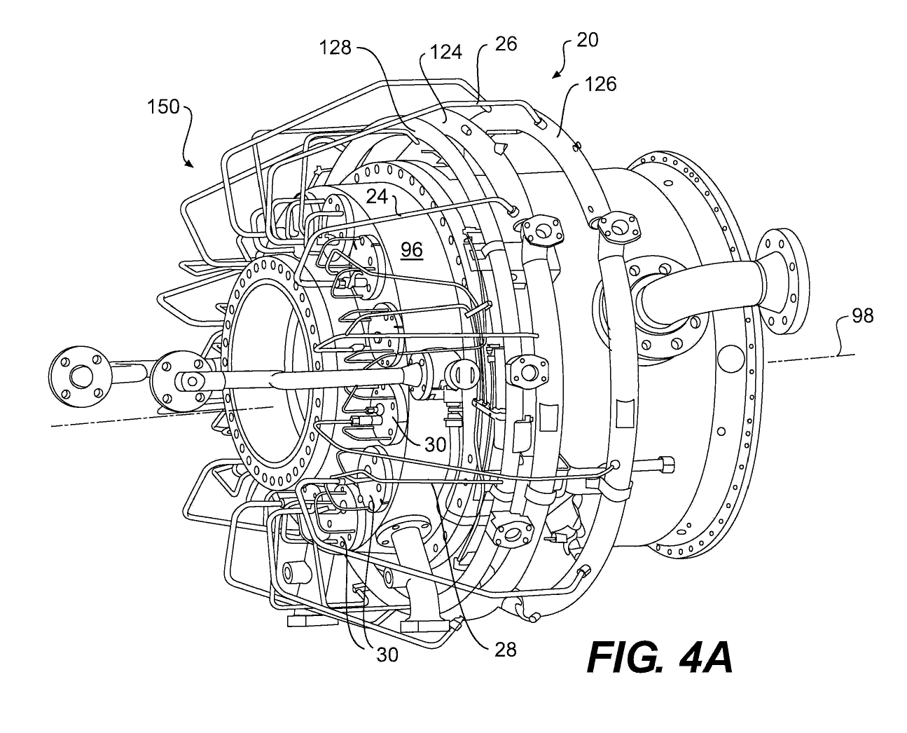

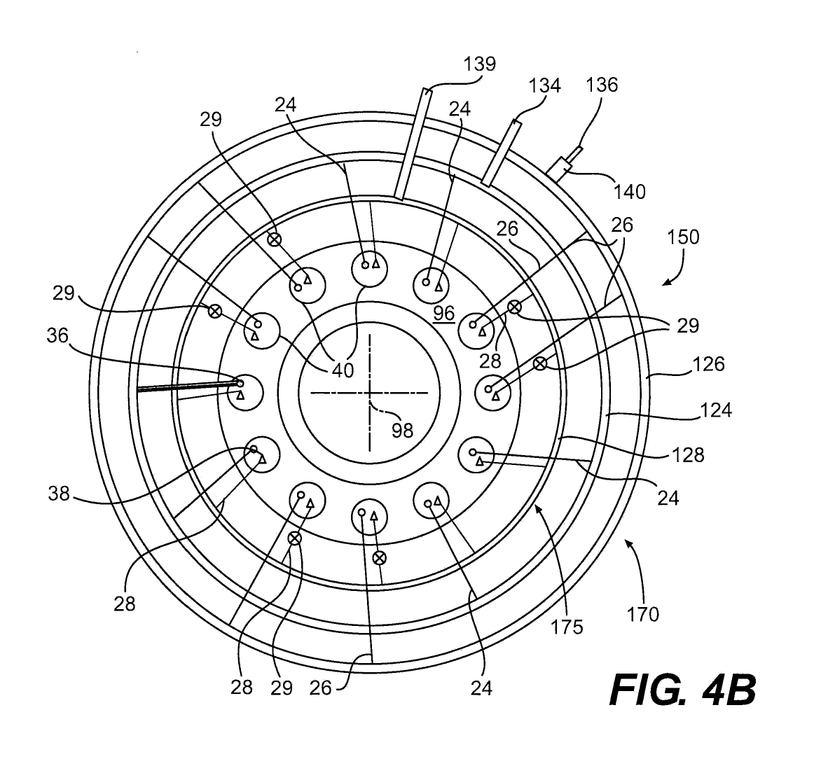

The fuel conduits that deliver fuel to the fuel injector 30 supplies the fuel from a fuel delivery system of the GTE 100. FIGS. 4A and 4B illustrate an exemplary gaseous fuel delivery system 150 of GTE 100. FIG. 4A depicts an external perspective view of the combustor system 20 showing the gaseous fuel delivery system 150, and FIG. 4B is a simplified schematic view of the gaseous fuel delivery system 150. In the discussion that follows, reference will be made to both FIGS. 4A and 4B. A plurality of fuel injectors 30 are arranged symmetrically about engine axis 98. These fuel injectors 30 are inserted into openings in an outer casing 96 of GTE 100 and positioned such that the first ends 44 of the fuel injectors 30 abut the combustor dome 51 (see FIG. 2). Thus positioned, flanges (32, 132) at the second end 46 of each fuel injector 30 are secured to the casing 96 using fasteners 33 (See FIGS. 3A and 3B). Fuel conduits of the gaseous fuel delivery system 150 are then coupled to the respective pipe fittings at the second end 46 of these fuel injectors 30.

The gaseous fuel delivery system 150 of GTE 100 includes a main gaseous fuel delivery system 170 and a pilot gaseous fuel delivery system 175. The main gaseous fuel delivery system 170 includes a first main fuel manifold 124 and a second main fuel manifold 126 arranged circumferentially about the GTE 100. The first and second main fuel manifolds 124, 126 are supplied with gaseous fuel from a common supply through conduits 134 and 136 respectively. A restriction device 140 (such as, an orifice, venturi, etc.) attached to conduit 136 restricts the flow of fuel into the second main fuel manifold 126 as compared to the first main fuel manifold 124. In some embodiments, the restriction device 140 may be an orifice plate (a plate with a hole in the middle) placed in a conduit through which fuel flows. The first main fuel manifold 124 provides the main fuel supply of selected fuel injectors 30 and the second main fuel manifold 126 provides the main fuel supply of the remaining fuel injectors 30. In some embodiments of GTE 100, as illustrated in FIG. 4B, every alternate pair of fuel injectors 30 are coupled to a different one of the first and second main fuel manifolds 124, 126. For instance, in an embodiment of GTE 100 using fuel injectors 30 with flanges 132 (illustrated in FIG. 3B), first conduits 24 fluidly couple the first pipe fitting 36 of every alternate pair of fuel injectors 30 to the first main fuel manifold 124, and second conduits 26 fluidly couple the first pipe fittings 36 of the remaining fuel injectors 30 to the second main fuel manifold 126. Since the restriction device 140 restricts the flow of fuel into the second main fuel manifold 126, the fuel injectors 30 supplied by the second main fuel manifold 126 will receive a lower volume (mass flow rate, etc.) of main fuel flow as compared to the fuel injectors 30 supplied by the first main fuel manifold 124. In order to maintain the desired total flow of fuel to the combustor 50 approximately the same, the fuel supplied to the first main fuel manifold 124 may be correspondingly increased to make up for the decrease in fuel to the second main fuel manifold 126. This corresponding increase can be achieved by providing appropriate fuel supply pressure.

It should be noted that, although every alternate pair of fuel injectors 30 are illustrated (in FIGS. 4A and 4B) as being coupled to a different one of the first and second main fuel manifolds 124, 126, this is only exemplary. In general, the fuel injectors 30 may be coupled to the main fuel manifolds 124, 126 in any manner so as to create a circumferential variation in the main fuel supply to different fuel injectors 30. For instance, in some embodiments, every alternate fuel injector 30 (or fuel injectors 30 in alternate quadrants or segments) may be coupled to a different one of the first and second main fuel manifolds 124, 126, while in other embodiments, a random pattern of fuel injectors 30 may be coupled to the different manifolds. It is also contemplated that, in some embodiments, a single main fuel manifold may be used to supply all the fuel injectors 30, and a variation in the main fuel supply to different fuel injectors 30 may be attained by attaching restriction devices 140 (or other flow control devices such as control valves) to the conduits that deliver the fuel from the manifold to selected fuel injectors 30.

The pilot gaseous fuel delivery system 175 of GTE 100 includes a pilot fuel manifold 128 arranged circumferentially about GTE 100. A conduit 139 supplies the pilot fuel manifold 128 with gaseous fuel from an external source, and conduits 28 deliver the gaseous fuel from the pilot fuel manifold 128 to the pilot fuel supply of each fuel injector 30. That is, conduits 28 connect the pilot fuel manifold 128 to the second pipe fitting 38 of the fuel injectors 30 to deliver pilot fuel to the fuel injectors 30. In some embodiments, control valves 29 (or other flow control devices) may be coupled to selected conduits 28 to vary or block the pilot fuel supply to the corresponding fuel injectors 30. In some embodiments, control valves 29 may be coupled to the pilot conduits 28 of those fuel injectors 30 in which the main fuel is supplied from the second main fuel manifold 126. In such embodiments, in addition to the main fuel supply to these fuel injectors 30 being lower (because of restriction device 140), the pilot fuel supply to these fuel injectors may also be varied or stopped. As noted above, the main fuel to the fuel injectors 30 supplied by the first main fuel manifold 124 may be increased to keep the total fuel supplied to the combustor approximately a constant. In some embodiments, control valves 29 may be provided in all conduits 28 and the pilot fuel supply to selected fuel injectors 30 may be varied by selectively controlling these control valves 29.

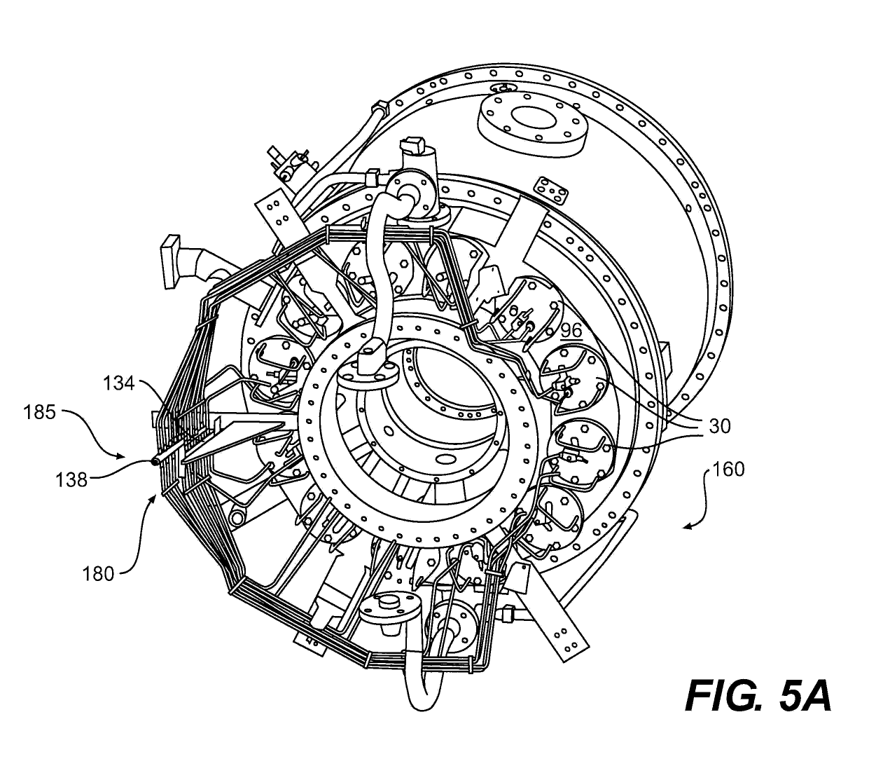

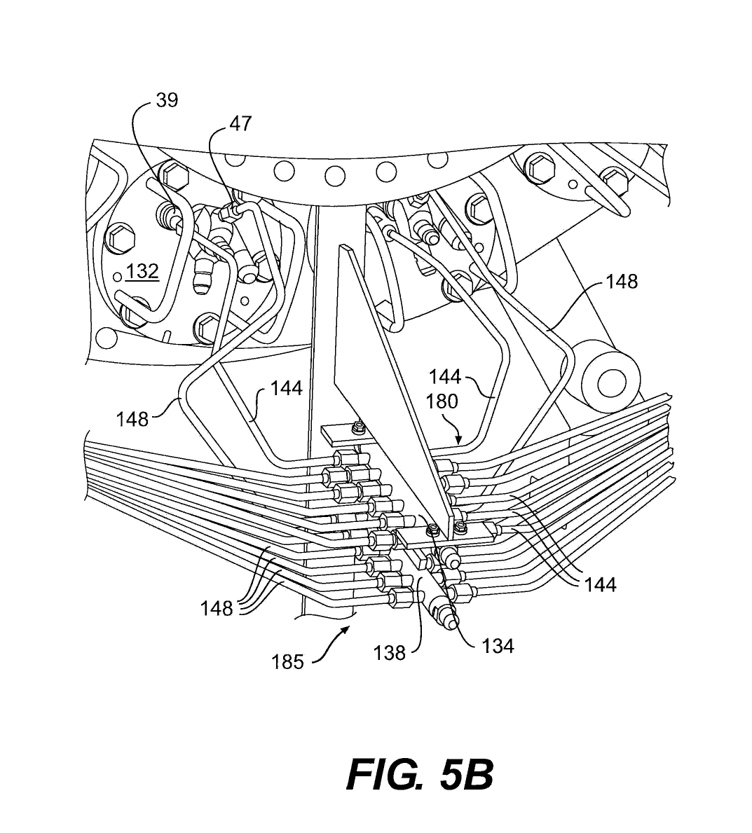

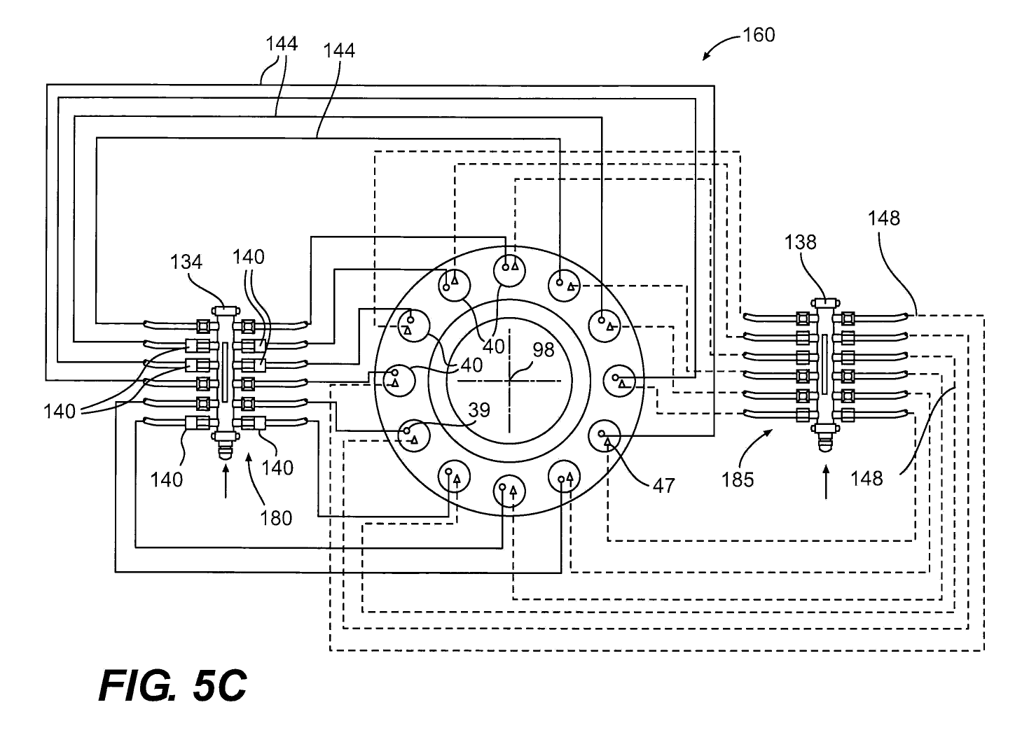

FIGS. 5A-5C illustrate the liquid fuel delivery system 160 of GTE 100. FIG. 5A illustrates a perspective view of the combustor system 20 with the liquid fuel delivery system 160 attached thereto. The liquid fuel delivery system 160 includes a main liquid fuel delivery system 180 and a pilot liquid fuel delivery system 185. FIG. 5B illustrates an enlarged view of a portion of the liquid fuel delivery system 160 showing main and pilot liquid fuel divider blocks 134, 138 fluidly coupled to the second end 46 of the fuel injectors 30 using conduits 144, 148. FIG. 5C illustrates a schematic view of the liquid fuel delivery system 160 showing the conduits 144, 148 coupled to the main and pilot liquid fuel divider blocks 134, 138. In the description that follows, reference will be made to FIGS. 5A-5C. Liquid fuel is directed into the main and pilot liquid fuel divider blocks 134, 138 from an external fuel supply source (shown by arrows in FIG. 5C).

The main liquid fuel delivery system 180 may include conduits 144 that extend between the main liquid fuel divider block 134 and the third pipe fitting 39 of the fuel injectors 30. These conduits deliver the main liquid fuel supply to the fuel injectors 30. Restriction devices 140 may be coupled to selected conduits 144 to reduce the amount of fuel directed to the fuel injectors 30 supplied by these conduits 144. In some embodiments, the restriction devices 140 may be incorporated in a pipe fitting that couples the conduit 144 to the divider block. As described with reference to the gaseous fuel supply system 150, although every alternate pair of fuel injectors 30 are illustrated as being coupled to the main liquid fuel block 134 through a restriction device 140, this is only exemplary. In general, restriction devices 140 may be coupled to selected conduits 144 to create a circumferential variation in the main fuel supply to different fuel injectors 30. For instance, in some embodiments, every alternate fuel injector 30 (or fuel injectors 30 in alternate quadrants or segments) may be coupled to main liquid fuel divider block 134 through a restriction device 140.

The pilot liquid fuel delivery system 185 may include conduits 148 that extend between the pilot liquid fuel divider block 138 and the fourth pipe fitting 47 to deliver the pilot liquid fuel to the fuel injectors 30. Although not illustrated in FIGS. 5A-5C, in some embodiments, restriction devices 140 or other flow control devices (such as, for example, control valves) may be coupled to some or all of the conduits 148 to selectively block or restrict the pilot fuel supply to selected fuel injectors 30. In some embodiments, these restriction or flow control devices may be coupled to the conduits 148 of those fuel injectors 30 in which main fuel supply is provided through a restriction device 140. In such embodiments, in addition to the main fuel supply to these fuel injectors 30 being lower (because of restriction device 140), the pilot fuel directed to the combustor 50 through these fuel injectors 30 may also be varied or stopped. The main fuel supplied through the conduits 144 without the restriction devices 140 may be increased to make up for the decrease in fuel discharged through some fuel injectors 30, and keep the total amount of fuel supplied to the combustor 50 approximately a constant.

Dual-fuel GTE 100 that operate on both gaseous and liquid fuels include both the gaseous fuel delivery system 150 (illustrated in FIGS. 4A-4B), and the liquid fuel delivery system 160 (illustrated in FIGS. 5A-5C). Note that the flange 132 applied with the liquid fuel delivery system 160 of FIG. 5A includes pipe fittings configured to couple a gaseous fuel delivery system 150 (see discussion related to FIGS. 3A and 3B). One or both of these fuel delivery systems may include restriction devices 140 or other flow control devices to create a circumferential variation in the fuel supply to the combustor 50.

### INDUSTRIAL APPLICABILITY

The disclosed gas turbine engines and the methods of operating these gas turbine engines may be used in any application where it is desired to reduce combustion induced oscillations (or pressure waves). Combustion of fuel in the combustor of a gas turbine engine produces thermo-acoustic pressure waves. To reduce these combustion induced pressure waves, fuel is directed to the fuel injectors 30 in such a manner to create a circumferential variation in the fuel supply to the combustor. This circumferential variation in the fuel supply to the combustor produces a corresponding circumferential variation in the temperature distribution in the combustor. As the combustion induced pressure waves traverse the resulting relatively hot and cold regions of the combustor, the pressure waves are attenuated.

To illustrate the reduction in combustion induced pressure waves, the operation of an exemplary gas turbine engine will now be described. A plurality of fuel injectors 30 are arranged annularly about an engine axis 98 to direct fuel-air mixture circumferentially into the combustor 50. A circumferential variation in the amount of fuel in the fuel-air mixture (entering the combustor 50) is created by reducing the quantity of fuel supplied to selected fuel injectors 30 (of the plurality of fuel injectors 30). The amount of fuel supplied to these fuel injectors 30 is reduced by directing the fuel to these fuel injectors 30 through restriction devices 140. In some embodiments, the circumferential variation in the combustor fuel supply may be further adjusted by reducing, or shutting off, the pilot fuel supply of the selected fuel injectors 30.

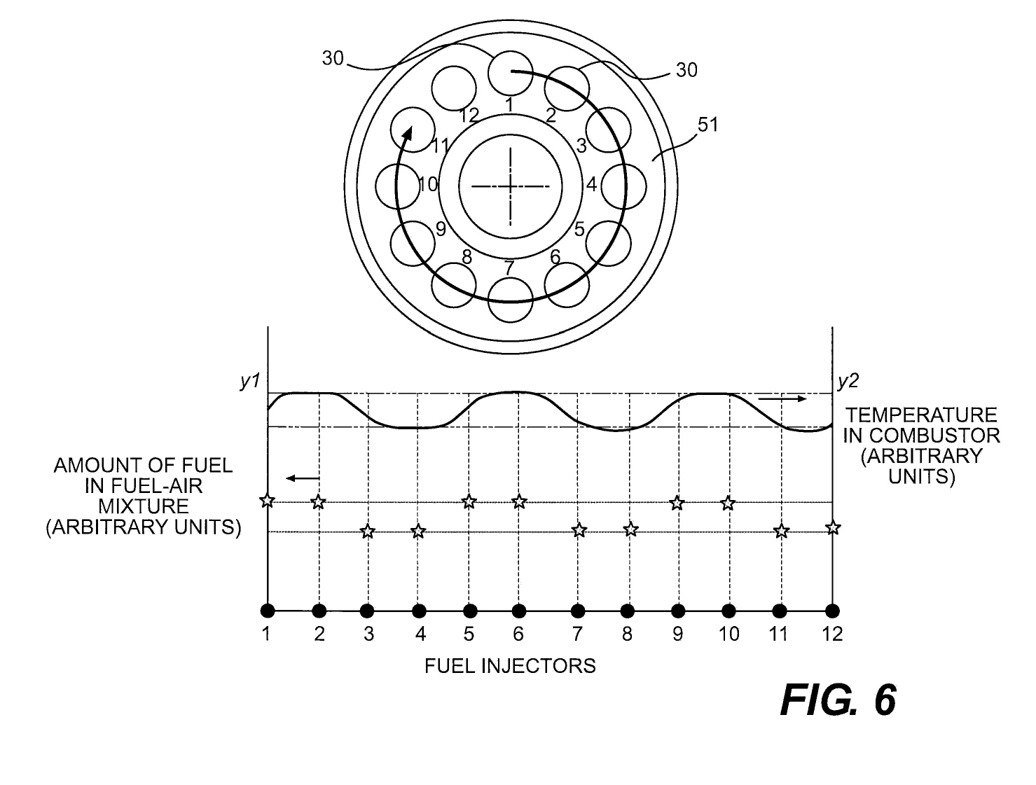

FIG. 6 is a schematic illustration of the circumferential variation in the fuel entering the combustor 50 and the resulting distribution in temperature in the combustor 50. The x-axis of FIG. 6 represents the dome 51 of the combustor 50 (with the fuel injectors 30) unwrapped along a linear axis. The Y1 axis of FIG. 6 represents the amount of fuel entering the combustor 50 through the different fuel injectors 30, and the Y2 axis represents the temperature distribution around the combustor 50 measured at a fixed distance from the dome 51. As illustrated in FIG. 6, the amount of fuel in the fuel-air mixture entering the combustor 50 through every alternate pair of fuel injectors 30 is lower that the adjacent pair. Although the exact reduction in the supplied fuel may depend on the application, in some embodiments, the amount of fuel directed through every alternate pair of fuel injectors 30 may be between about 0.67-0.98 times the amount of fuel directed through the adjacent pair of fuel injectors 30. This fuel-air mixture ignites in the combustor 50 and produces high temperature combustion gases. The temperature of these combustion gases is a function of the fuel content in the fuel-air mixture. Because a lower amount of fuel enters the combustor 50 through every alternate pair of fuel injectors 30, the temperature of the combustion gases proximate these fuel injectors 30 will be correspondingly lower. These alternating low temperature zones in the combustor 50 interferes with, and dampen, the circumferential pressure waves in the combustor 50 by introducing time lags in the propagation of the pressure wave.

It will be apparent to those skilled in the art that various modifications and variations can be made to the disclosed gas turbine engine. Other embodiments will be apparent to those skilled in the art from consideration of the specification and practice of the disclosed gas turbine engine. It is intended that the specification and examples be considered as exemplary only, with a true scope being indicated by the following claims and their equivalents.

What is claimed is:

1. A method for operating a turbine engine having a plurality of fuel injectors arranged circumferentially in a combustor, each fuel injector having a main fuel supply and a pilot fuel supply, the method comprising:
supplying fuel to the plurality of fuel injectors through the main fuel supply to create a circumferential thermal gradient in the combustor.

2. The method of claim 1, wherein the thermal gradient includes alternating cooler and hotter portions around the combustor.

3. The method of claim 1, wherein the thermal gradient is provided by supplying less fuel to at least one of the fuel injectors than another of the fuel injectors.

4. The method of claim 3, wherein the providing of less fuel to at least one of the fuel injectors includes supplying less fuel to a plurality of circumferentially adjacent injectors.

5. The method of claim 4, wherein the providing of less fuel to a plurality of circumferentially adjacent injectors, includes providing more fuel to pairs of injectors on each circumferential side of the fuel injectors provided with less fuel.

6. The method of claim 5, wherein the providing of less and more fuel to the fuel injectors is provided in an alternating fashion about the entire circumference.

7. The method of claim 1, further including restricting the flow of fuel through the main fuel supply of a plurality of fuel injectors to provide the thermal gradient.

8. The method of claim 1, wherein the supplying of fuel includes supplying liquid fuel.

9. The method of claim 1, wherein the supplying of fuel includes supplying gaseous fuel.

10. The method of claim 1, further including supplying fuel to the fuel injectors through the pilot fuel supply to create the circumferential thermal gradient.

11. The method of claim 10, wherein the supplying of fuel to the fuel injectors through the pilot fuel supply includes cutting off fuel supply to pilot assemblies of a plurality of fuel injectors.

12. The method of claim 11, further including providing less fuel to the main fuel supply of those fuel injectors in which the fuel supply to the pilot assemblies are cut off.

13. A method for operating a turbine engine having multiple fuel injectors arranged circumferentially in a combustor, each fuel injector having a main fuel supply and a pilot fuel supply, the method comprising:
supplying a first quantity of main fuel to a first plurality of fuel injectors of the multiple fuel injectors; and
supplying a second quantity of main fuel lower than the first quantity to a second plurality of fuel injectors of the multiple fuel injectors.

14. The method of claim 13, wherein the first plurality and the second plurality of fuel injectors are alternating pairs of fuel injectors.

15. The method of claim 13, further including shutting of the pilot fuel supply of the second plurality of fuel injectors.

16. The method of claim 13, wherein supplying a second quantity of main fuel includes directing the main fuel supply to the second plurality of fuel injectors through a restriction device to reduce the flow of fuel therethrough.

17. A method for operating a turbine engine having a plurality of fuel injectors arranged circumferentially in a combustor, each fuel injector having a main fuel supply and a pilot fuel supply, the method comprising:
directing main fuel to the plurality of fuel injectors from a common fuel supply;
directing a first quantity of the main fuel to a first set of fuel injectors; and
passing the main fuel through a restriction device to direct a second quantity of main fuel lower than the first quantity to a second set of fuel injectors.

18. The method of claim 17, further including directing pilot fuel to the plurality of fuel injectors.

19. The method of claim 18, wherein directing the second quantity of main fuel includes cutting off the flow of fuel into the combustor through the pilot assemblies of the second set of fuel injectors.

20. The method of claim 20, wherein the first set and the second set of fuel injectors are alternating pairs of fuel injectors.
